(19) United States
(12) Patent Application Publication
(10) Pub. No.: US 2026/0147102 A1
(43) Pub. Date: May 28, 2026

(54) LIDAR DEVICE AND OPERATING METHOD THEREOF

(71) Applicant: SAMSUNG ELECTRONICS CO., LTD., Suwon-si (KR)

(72) Inventors: Jisan LEE, Suwon-si (KR); Byunghoon KO, Suwon-si (KR); Jangwoo YOU, Suwon-si (KR)

(73) Assignee: SAMSUNG ELECTRONICS CO., LTD., Suwon-si (KR)

(21) Appl. No.: 19/194,855

(22) Filed: Apr. 30, 2025

(30) Foreign Application Priority Data
Nov. 25, 2024 (KR) 10-2024-0170063

(51) Int. Cl. G01S 7/497; G01S 7/487; G01S 7/493

(52) U.S. Cl. CPC G01S 7/497; G01S 7/487; G01S 7/493

(57) ABSTRACT

An operating method of a light detection and ranging (LiDAR) device includes generating an optical signal, irradiating the optical signal toward an object as a transmission signal, receiving a reception signal reflected from the object, obtaining, through an optical ray simulation, a correction coefficient for correcting a light intensity of the reception signal, and detecting a distance between the LiDAR device and the object or a speed of the object by using the transmission signal, the reception signal, and the correction coefficient.

### CROSS-REFERENCE TO RELATED APPLICATION

This application is based on and claims priority under 35 U.S.C. § 119 to Korean Patent Application No. 10-2024-0170063, filed on Nov. 25, 2024, in the Korean Intellectual Property Office, the disclosure of which is incorporated by reference herein in its entirety.

### BACKGROUND

### 1. Field

The disclosure relates to a LiDAR device and an operating method thereof.

### 2. Description of the Related Art

Light detection and ranging (LiDAR) devices are used as sensors for precise detection of the surrounding environment in various fields including, but not limited to, autonomous vehicles, aerospace, geology, drones, robots, and precision measurement devices. For example, LiDAR devices are used to measure a distance to an object or a speed of the object by using light. In particular, LiDAR devices use a time of flight (ToF) method or a frequency modulated continuous wave (FMCW) method as an operation principle.

For example, a ToF type LiDAR device may measure a distance to an object by transmitting pulsed light and analyzing a returning signal reflected from the object and measuring the round trip flight time of light. On the other hand, a FMCW type LiDAR device may simultaneously measure a distance to an object and a speed of the object by analyzing a frequency difference between a transmission signal and a reception signal using a continuous wave of which frequency is modulated.

### SUMMARY

Provided are a LiDAR device and an operating method thereof. The technical problem to be achieved by the disclosure is not limited to the technical problems as described above, and other technical problems may be inferred from the following embodiments.

Additional aspects will be set forth in part in the description which follows and, in part, will be apparent from the description, or may be learned by practice of the presented embodiments of the disclosure.

According to an aspect of the disclosure, there is provided an operating method of a light detection and ranging (LiDAR) device, the operating method including: generating an optical signal; irradiating a transmission signal towards an object, the transmission signal based on the optical signal; receiving a reception signal reflected from the object; obtaining, based on an optical ray simulation, a correction coefficient for correcting a light intensity of the reception signal; and detecting a distance between the LiDAR device and the object or a speed of the object based on the transmission signal, the reception signal, and the correction coefficient.

According to another aspect of the disclosure, there is provided a light detection and ranging (LiDAR) device including: a signal generator configured to generate an optical signal; a transmitter configured to irradiate a transmission signal towards an object, the transmission signal based on the optical signal; a receiver configured to receive a reception signal reflected from the object; and a processor configured to: obtain a correction coefficient for correcting a light intensity of the reception signal based on an optical ray simulation, and detect a distance between the LIDAR device and the object or a speed of the object based on the transmission signal, the reception signal, and the correction coefficient.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a light detection and ranging (LiDAR) device;

FIG. 2 is a diagram illustrating a LiDAR device according to an embodiment;

FIG. 3 shows graphs illustrating a transmission signal, a reception signal, and a beat signal of the LiDAR device of FIG. 2;

FIGS. 4A, 4B and 4C show graphs illustrating signals acquired by the LiDAR device of FIG. 2 with respect to an object located at a short distance;

FIGS. 5A, 5B and 5C show graphs illustrating signals acquired by the LiDAR device of FIG. 2 with respect to an object located at a long distance;

FIG. 6 is a flowchart illustrating an operating method of a LiDAR device according to an embodiment;

FIG. 7 is a graph illustrating a correction coefficient obtained through an optical ray simulation according to an embodiment;

FIGS. 8A and 8B show graphs illustrating a correction coefficient for correcting a light intensity of a reception signal; and

FIGS. 9A, 9B, 9C, 9D, 9E, 9F, 9G, 9H and 9I show graphs for comparing frequency spectra acquired by a LiDAR device for a near-field object, a far-field object, and an ultra-near-field object, according to various embodiments.

### DETAILED DESCRIPTION

Reference will now be made in detail to embodiments, examples of which are illustrated in the accompanying drawings, wherein like reference numerals refer to like elements throughout. In this regard, embodiments of the disclosure may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The terms used in the embodiments have selected the currently widely used general terms possible in consideration of their functions in the embodiments, but this may vary depending on the intention or precedent of a technician in the art, the emergence of a new technology, and the like. In addition, in certain cases, there are arbitrarily selected terms, and in this case, the meaning will be described in detail in the description part of the embodiment. Therefore, the terms used in the embodiments should not be defined simply as the names of the terms, but should be defined based on the meanings of the terms and the overall content of the embodiments.

In the descriptions of embodiments, when a part is connected to another part, it includes not only a case of being directly connected, but also a case of being electrically connected with another component therebetween. Singular expressions include plural expressions unless the context clearly means otherwise. In addition, when a part “contains” a component, this means that it may contain other components, rather than excluding other components, unless otherwise stated.

Terms such as “comprising”, “includes”, or the like used in the embodiments should not be construed as necessarily including all of the various components or operations described in the specification, and it should be construed that some of the components or some operations may not be included, or additional components or operations may be included.

In addition, terms including ordinal numbers, such as “first” or “second” used in this specification, may be used to describe various components, but the components should not be limited by the terms. The terms may be used only for the purpose of distinguishing one component from another.

The description of the following embodiments should not be construed as limiting the scope of rights, and what those skilled in the art may easily infer should be construed as belonging to the scope of rights of the embodiments. Hereinafter, embodiments solely for illustration will be described in detail with reference to the accompanying drawings.

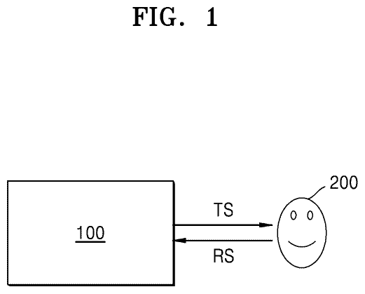

FIG. 1 is a diagram illustrating a light detection and ranging (LiDAR) device 100.

The LiDAR device 100 may be used as a sensor for obtaining distance information and/or speed information about an object in the vicinity of the LiDAR device 100. For example, the LiDAR device 100 may be used as a sensor for obtaining distance information and/or speed information about an object in front of the LiDAR device 100 in real time. For example, the LiDAR device 100 may be applied to autonomous vehicles, aerospace, geology, drones, robots, home appliances, precision measurement devices, and the like. For example, the LiDAR device 100 may be a device using light detection and ranging.

The LiDAR device 100 may emit light as a transmission signal (TS) to an object 200 located in front of the LiDAR device 100, and analyze the transmission signal together with a reception signal (RS) reflected from the object 200, thereby acquiring information about the distance to the object 200 and/or speed of the object 200 in real time. According to embodiments of the disclosure, the distance to the object may mean a distance between the LiDAR device and the object, and may hereinafter be referred to as distance information about the object. For example, the distance to the object may mean the distance the object is away from the LiDAR device.

For example, the LiDAR device 100 may irradiate pulsed light to the object 200 and obtain distance information of the object 200 in real time by analyzing a signal reflected from the object 200. The LiDAR device 100 may calculate the distance to the object 200 based on a time of flight (ToF) from irradiating the object 200 with a pulse-type optical signal to detecting a signal reflected from the object 200. In other words, the LIDAR device 100 may obtain distance information of the object 200 by measuring a period of time from a first time when the optical signal is irradiated to the object 200 to a second time when the signal reflected from the object 200 is received.

As another example, the LiDAR device 100 may irradiate a signal having a frequency varying over time to the object 200 as a transmission signal. The LiDAR device 100 may receive a signal reflected from the object 200 as a reception signal, and may simultaneously acquire information on a distance to the object 200 and a speed of the object 200 by analyzing a signal generated by an interference phenomenon between the transmission signal and the reception signal.

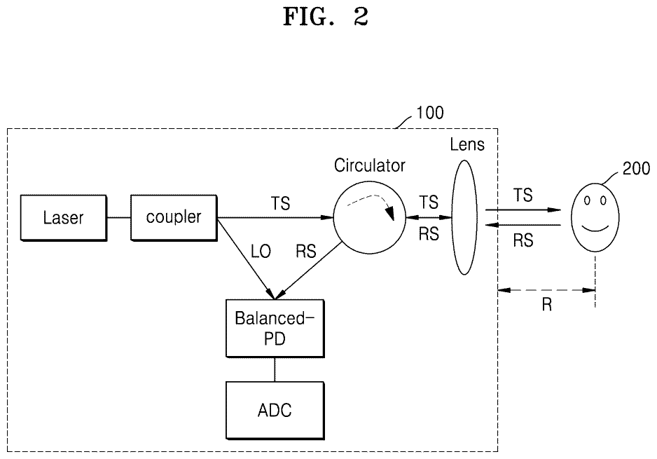

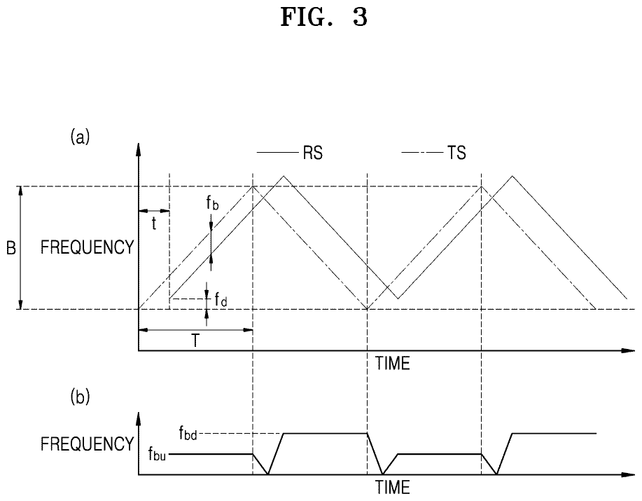

Hereinafter, referring to FIGS. 2 and 3, a LiDAR device 100 that measures a distance to a target object 200 and speed of the target object 200 using a signal having a frequency that changes over time will be specifically described.

FIG. 2 is a diagram illustrating a LiDAR device 100 according to an embodiment.

Referring to FIG. 2, a LiDAR device 100 according to an embodiment may include a signal generation unit, a transmission unit, a reception unit, and a processor. Although FIG. 2 illustrates components related to an embodiment of the LIDAR device 100, the disclosure is not limited thereto, and as such, it may be understood by those of ordinary skill in the technical field that the LIDAR device 100 may further include other general components in addition to the components shown in FIG. 2 or some components of FIG. 2 may be deleted.

The signal generation unit may generate an optical signal. The signal generation unit may generate light of a specific wavelength. The signal generation unit may generate a plurality of different wavelength bands of light. For example, the signal generation unit may emit light in an infrared region. The use of light in the infrared region may prevent mixing with natural light in the visible light region including sunlight. However, the disclosure is not necessarily limited to the infrared region, and as such, according to some embodiments, light in various wavelength regions may be emitted. In this case, correction for removing information of the mixed natural light may be required.

The signal generation unit may generate an optical signal using a laser light source, but the disclosure is not limited thereto. The signal generation unit may use a light source such as, but not limited to, a solid-state laser, a fiber laser, an edge emitting laser, a vertical-cavity surface emitting laser (VCSEL), a distributed feedback laser, and a super luminescent diode (SLD). For example, the signal generation unit may include a laser diode (LD). According to an embodiment, the signal generation unit may be included in other devices, and need not necessarily be configured with hardware included in the LIDAR device 100. For example, the signal generation unit may be included in a separate device external to the LIDAR device 100.

According to an embodiment, the signal generation unit may further include an optical modulator for modulating an optical signal. The signal generation unit may modulate the frequency of the optical signal to change over time using the optical modulator. For example, the signal generation unit may modulate the amplitude and/or phase of the optical signal so that the frequency of the optical signal changes into a continuous form that increases or decreases over time.

The signal generation unit may modulate the frequency of the optical signal using a method including, but not limited to, an electrical method, a thermal method, and/or a mechanical method. For example, the signal generation unit may modulate the frequency of the optical signal using an optical modulator including at least one phase shifter or phase shifting element. In this case, the phase shifter may include at least one or more elements including, but not limited to, a gain element, an all-pass filter, a Bragg grating, a dispersion material element, a wavelength tuning element, and a phase tuning element.

The transmission unit may emit a transmission signal toward the object 200. The transmission unit may separate the optical signal into a local oscillator signal LO and a transmission signal TS, and irradiate the transmission signal TS towards the object 200. For example, the transmission unit may use an optical coupler (or beam splitter) to separate the optical signal into the local oscillator signal LO and the transmission signal TS. The transmission unit may irradiate the object 200 with the separated optical signal as the transmission signal TS.

The transmission unit may focus the transmission signal TS to the object 200 through a lens. The transmission unit may irradiate the transmission signal TS in a desired direction using a lens so that the transmission signal TS is focused on a specific region. For example, the transmission unit may make the transmission signal TS parallel using a collimator lens, and accordingly, the transmission signal TS may be irradiated to a narrow region of the object 200.

The LiDAR device may include an optical connector for connecting the signal generation unit with the lens, and in this case, the transmission signal may be emitted from an end of the optical connector and irradiated toward the object through the lens.

The reception unit may receive a reception signal RS reflected (or scattered) from the object 200. The reception unit may include a photodetector for receiving the local oscillator signal LO and the reception signal RS. For example, the reception unit may include a balanced-photodetector (BPD). The BPD may include two photodetectors, and the BPD may receive the local oscillator signal LO in a first direction and the reception signal RS in a second direction. For example, the BPD may receive the local oscillator signal LO from the first direction in a first detector and the reception signal RS from the second direction in a second detector.

According to an embodiment, the reception unit may further include an optical coupler for separating the local oscillator signal LO and the reception signal RS at a specific ratio. For example, after receiving the local oscillator signal LO and the reception signal RS through the optical coupler, the reception unit may distribute the local oscillator signal LO and the reception signal RS equally into two output paths, and the BPD may receive the local oscillator signal LO in a first path and the receiving signal RS in a second path.

The reception unit may transmit a reception signal RS to the photodetector through the lens. The reception unit may irradiate the reception signal RS in a desired direction using a lens and adjust the reception signal RS to face a predetermined direction. For example, the reception unit may use a collimator lens to cause the reception signal RS to be focused on the photodetector. According to another embodiment, the reception unit may fine-tune the direction of the reception signal TS using a scanning lens.

The LiDAR device 100 may further include a circulator. The circulator may be provided on an optical path of the LiDAR device 100 to separate the transmission signal TS and the reception signal RS so that the transmission signal TS and the reception signal RS do not interfere with each other. In other words, the circulator may separate an optical path through which the transmission signal TS is transmitted from an optical path through which the reception signal RS is transmitted within the LiDAR device 100. In an example case in which the transmission signal TS passes through the lens along a first optical path through the circulator and is irradiated to the object 200, the reception signal RS may be received through the lens and transmitted to the photodetector along a second optical path different from the first optical path through the circulator.

The processor may be electrically or operatively connected to components in the LIDAR device 100 to control the overall operation of the LIDAR device 100. For example, the processor may be electrically connected to the signal generation unit to modulate the frequency of the transmission signal TS to change over time.

According to an embodiment, the processor may be electrically connected to the transmission unit and the reception unit to detect a distance between the LiDAR device 100 and the object 200 and/or a speed of the object 200 using the transmission signal TS and the reception signal RS. For example, the processor may obtain analog electrical signals from the reception unit (or photodetector) and digitize (or binarize) the signals using an analog-digital converter (ADC). Thereafter, the processor may convert the digital signal into frequency domain information through fast Fourier transform (FFT) and detect a distance to the object 200 and/or speed information of the object 200 by analyzing the frequency domain information.

FIG. 3 shows graphs illustrating a transmission signal TS, a reception signal RS, and a beat signal of the LiDAR device 100 of FIG. 2.

In graph (a) of FIG. 3, the transmission signal TS and the reception signal RS are shown by a single-dot line and a solid line, respectively. In this case, “B” indicates a modulation bandwidth and “T” indicates a modulation period. According to some embodiments of the disclosure, the modulation bandwidth “B” means a range in which the frequency of the transmission signal TS changes, and may mean a difference between the maximum frequency and the minimum frequency of the transmission signal TS. According to some embodiments of the disclosure, the modulation period “T” means a time taken for the transmission signal TS to completely modulate the frequency of the transmission signal TS, and may mean a time taken for the transmission signal TS to complete frequency sweep (e.g., up-chirp) and down-chirp once.

In an example case in which the frequency of the transmission signal TS irradiated from the LIDAR device (e.g., the LIDAR device 100 of FIG. 2) to the object (e.g., the object 100 of FIG. 2) linearly increases or decreases, the frequency of the reception signal RS reflected from the object and returned to the LIDAR device also linearly increases or decreases.

Since there is a delay time t between a first timepoint when the transmission signal TS is transmitted from the LIDAR device and a second timepoint when the LIDAR device receives the reception signal RS, a certain frequency difference fb may be formed between the transmission signal TS and the reception signal RS. In other words, when the transmission signal TS and the reception signal RS are mixed with each other, a beat signal having a constant frequency difference fb may be generated. According to some embodiments of the disclosure, a beat signal is a signal generated by an interference phenomenon between the transmission signal TS and the reception signal RS, and refers to a signal including a constant frequency difference fb as a beat frequency.

However, since the distance between the LIDAR device and the object and the speed of the object change due to the movement of the object, a frequency change corresponding to the Doppler frequency fa may occur in the transmission signal TS and the reception signal RS. Accordingly, different frequency differences f_{bu} and f_{bd} occur in up-chirp and down-chirp, respectively.

In graph (b) of FIG. 3, an up-beat signal f_{bu} and a down-beat signal f_{bd} generated from the transmission signal TS and the reception signal RS are shown. The up-beat signal f_{bu} may represent a beat frequency corresponding to up-chirp, the down-beat signal f_{bd} may represent a beat frequency corresponding to down-chirp, and may satisfy Equations 1 and 2 below.

$${f}_{bu} = {f}_{b} - {f}_{d} \qquad [ Equation 1 ]$$

$${f}_{bd} = {f}_{b} + {f}_{d} \qquad [ Equation 2 ]$$

Meanwhile, the Doppler frequency fa may be proportional to the relative speed v of the object with respect to the LIDAR device and inversely proportional to the wavelength λ of the transmission signal TS, as shown in Equation 3 below.

$${f}_{d} = \frac{2 v}{λ} \qquad [ Equation 3 ]$$

Accordingly, the distance R between the LIDAR device and the object and the relative speed v of the object may be calculated as in Equations 4 and 5 below. For example, the distance R between the LIDAR device and the object may be proportional to the average of the up-beat signal f_{bu} and the down-beat signal f_{bd}, the relative speed v of the object may be proportional to the difference between the up-beat signal f_{bu} and the down-beat signal f_{bd}, and the slope in Equation 4 below may mean the speed at which the frequency is modulated.

$$R = \frac{c}{4 slope} ( {f}_{bd} + {f}_{bu} ) \qquad [ Equation 4 ]$$

$$v = \frac{λ}{4} ( {f}_{bd} - {f}_{bu} ) \qquad [ Equation 5 ]$$

That is, the LIDAR device may detect distance to the object 200 and/or speed information of the object 200 by generating a beat signal based on the transmission signal TS and the reception signal RS and analyzing the beat signal.

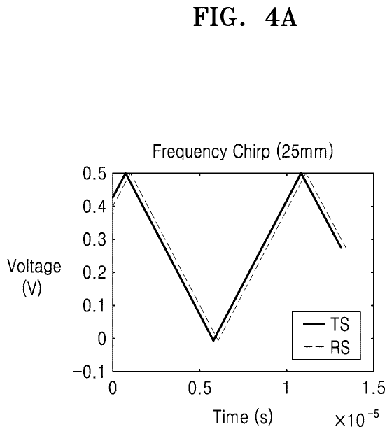

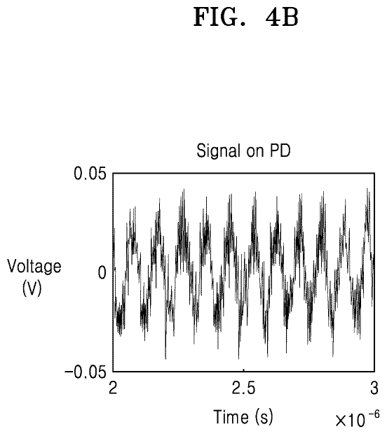

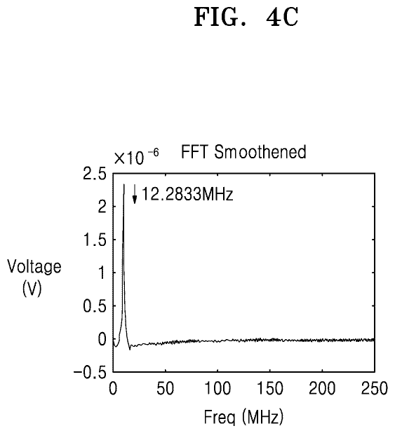

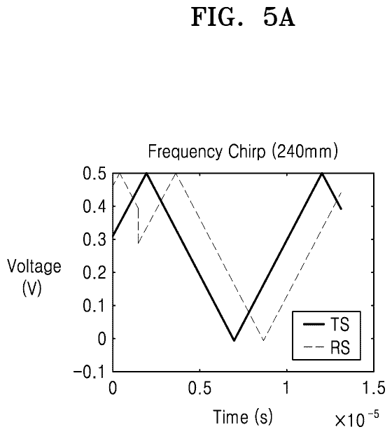

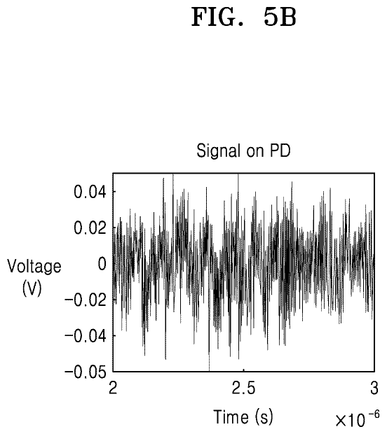

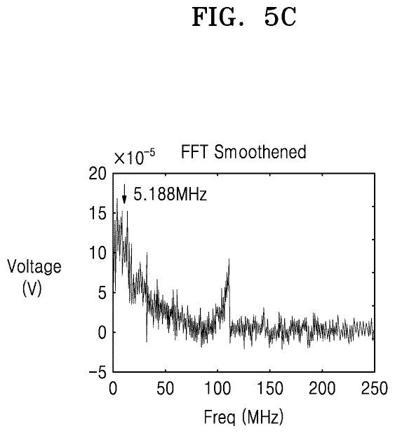

FIGS. 4A, 4B and 4C show graphs illustrating signals acquired by the LiDAR device 100 of FIG. 2 with respect to an object located in a short distance 25 m. FIGS. 5A, 5B and 5C show graphs illustrating signals acquired by the LiDAR device 100 of FIG. 2 with respect to an object located in a long distance 240 m. That is, FIGS. 4A, 4B and 4C show graphs illustrating signals obtained by the LIDAR device in an example case in which the distance between the LIDAR device and the object is 25 m, and FIGS. 5A, 5B and 5C show graphs illustrating signals obtained by the LIDAR device in an example case in which the distance between the LIDAR device and the object is 240 m.

Referring to FIGS. 4A, 4B, 4C, 5A, 5B and 5C show the LIDAR device (e.g., the LIDAR device 100 of FIG. 2) may generate a beat signal by irradiating an object (e.g., the object 200 of FIG. 2) with a transmission signal TS, and mixing a reception signal RS reflected from the object with a local oscillator signal LO of the LIDAR device. The beat signal is represented in a time domain, and the LiDAR device may convert the beat signal into a frequency domain using Fast Fourier Transform (FFT). The LiDAR device may calculate distance information and/or speed information of the object by detecting a peak frequency in the converted frequency spectrum.

For example, analog electrical signals for the transmission signal TS and the reception signal RS are shown in solid and dotted lines in FIGS. 4A and 5A, and beat signals obtained from the reception unit (or photodetector) are shown in the time domain in FIGS. 4B and 5B.

Comparing the graph in FIG. 4A with the graph in FIG. 5B, it may be seen that the frequency difference between the transmission signal TS and the reception signal RS is greater when the distance between the LIDAR device and the object is a long distance 240 m than when the distance between the LIDAR device and the object is a short distance 25 m. This is because the longer the distance between the LIDAR device and the object, the longer the delay time (e.g., the delay time t in FIG. 3) between a time when the transmission signal TS is transmitted and a time when the reception signal RS is received.

Furthermore, the longer the delay time, the greater the frequency difference (e.g., the frequency difference fb in FIG. 3) between the transmission signal TS and the reception signal RS, and thus, the frequency of the beat signal will also increase. Comparing the graph in FIG. 4B with the graph in FIG. 5B, it may be seen that the beat signal illustrated in the graph in FIG. 5B has a higher frequency than the beat signal illustrated in the graph in FIG. 4B. In other words, it may be seen that the LiDAR device acquires a beat signal having a much higher frequency when the object is at a long distance 240 m than when the object is at a short distance 25 m.

In addition, in an example case in which the distance between the LiDAR device and the object increases, the strength of the reception signal reflected from the object and returned to the LiDAR device may be weakened. Accordingly, when the distance between the LIDAR device and the object is longer 240 m than when the distance between the LIDAR device and the object is a short distance 25 m, the signal to noise ratio (SNR) of the LIDAR device is inevitably lowered.

The graphs in FIGS. 4C and 5C show the results of converting the beat signals of the graphs in FIGS. 4B and 5B into the frequency domain, respectively, by the LiDAR device using Fast Fourier Transform (FFT). In other words, the frequency spectra of the beat signals of the graphs in FIGS. 4B and 5B converted into the frequency domain through Fast Fourier Transform (FFT) are shown in the graphs in FIGS. 4C and 5C, respectively.

Comparing the graph in FIG. 4C with the graph in FIG. 5C, it may be seen that the LIDAR device may detect a peak frequency (e.g., about 12 MHz) that is almost similar to the actual frequency (e.g., about 12 MHz), from the result shown in the graph in FIG. 4C, while only a peak frequency (e.g., about 5 MHz) with a frequency lower than the actual frequency (e.g., about 110 MHz) may be detected from the result shown in the graph in FIG. 5C. In this case, “the actual frequency” indicates the peak frequency of the signal reflected from an object (e. g, a wall) that is a certain distance away from the LIDAR device. For example, the LIDAR device may detect the actual frequency as about 12 MHz when the object is at a close distance (e.g., 25 m), and may detect the actual frequency as about 110 MHz when the object is at a long distance (e.g., 250 m).

In an example case in which the distance between the LIDAR device and the object is relatively close (e.g., 25 m), the frequency difference between the transmission signal TS and the reception signal RS is not large and the strength of the reception signal RS is not significantly reduced, and thus, the LIDAR device may relatively accurately detect the distance to the object and/or speed of the object. Meanwhile, in an example case in which the distance between the LIDAR device and the object is relatively far (e.g., 240 m), the frequency difference between the transmission signal TS and the reception signal RS increases and the strength of the reception signal RS decreases significantly, and thus it may be difficult for the LIDAR device to accurately detect the distance to the object and/or speed of the object.

Accordingly, in order for the LiDAR device to accurately detect the distance to the object and/or speed of the object, a process of performing appropriate correction on the strength of the reception signal RS according to the distance to the object may be required. According to one or more embodiments of the disclosure, a LiDAR device capable of accurately detecting distance information and/or speed information for objects located at a long distance as well as objects located at a short distance by correcting the light intensity of the reception signal RS using optical ray simulation is provided, and will be described in detail with reference to the following drawings.

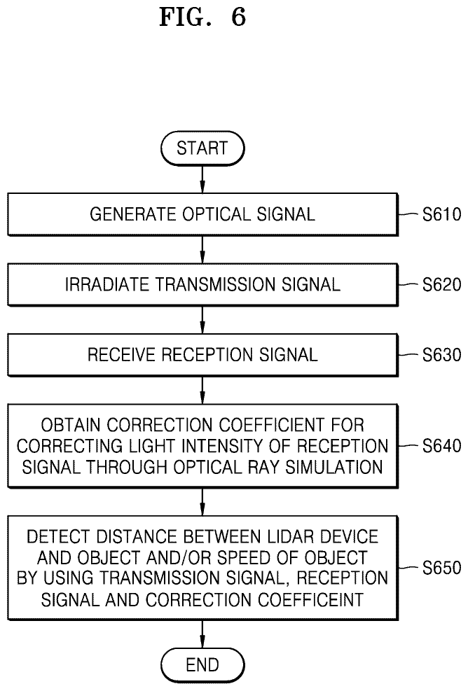

FIG. 6 is a flowchart illustrating an operating method of a LiDAR device according to an embodiment.

In operation S610, the method may include generating an optical signal. For example, the LiDAR device may generate an optical signal. For example, a ToF driving type LiDAR device may generate a pulse-type optical signal. According to another embodiment, a FMCW driving type LiDAR device may generate continuously emitted optical signals. That is, the LiDAR device may generate various types of optical signals according to embodiments.

The LiDAR device may include a signal generation unit for generating an optical signal. The signal generation unit may generate light of a specific wavelength. The signal generation unit may generate a plurality of different wavelength bands of light. For example, the signal generation unit may emit light in an infrared region. The use of light in the infrared region may prevent mixing with natural light in the visible light region including sunlight. However, embodiments are not necessarily limited to the infrared region and light in various wavelength regions may be emitted. In this case, correction for removing information of the mixed natural light may be required.

The signal generation unit may generate an optical signal using a laser light source, but is not limited thereto. The signal generation unit may use a light source such as a solid-state laser, a fiber laser, an edge emitting laser, a vertical-cavity surface emitting laser (VCSEL), a distributed feedback laser, and a super luminescent diode (SLD). For example, the signal generation unit may include a laser diode. According to an embodiment, the signal generation unit may be included in other devices, and need not necessarily be configured with hardware included in the LIDAR device.

The LiDAR device may further include an optical modulator for modulating an optical signal. The optical modulator may modulate the frequency of the optical signal to change over time. For example, the optical modulator may modulate the amplitude and/or phase of the optical signal so that the frequency of the optical signal changes into a continuous form that increases or decreases over time.

The optical modulator may modulate the frequency of the optical signal using an electrical method, a thermal method, and/or a mechanical method. For example, the LIDAR device may modulate the frequency of the optical signal using an optical modulator including at least one phase shifter. In this case, the phase shifter may include at least one or more elements including, but not limited to, a gain element, an all-pass filter, a Bragg grating, a dispersion material element, a wavelength tuning element, and a phase tuning element.

In operation S620, the method may include irradiating a transmission signal. For example, the LiDAR device may emit an optical signal toward an object as a transmission signal. The LiDAR device may irradiate an object with an optical signal through a transmission unit. According to another embodiment, the LIDAR device may separate the optical signal into a local oscillator signal and a transmission signal through the transmission unit, and irradiate the transmission signal to the object. For example, the transmission unit may use an optical coupler (or beam splitter) to separate the optical signal into a local oscillator signal and a transmission signal, and the transmission unit may irradiate the object with the separated optical signal as a transmission signal.

The LiDAR device may further include a lens for focusing the transmission signal on the object. The LIDAR device may transmit a transmission signal to the lens through an optical connector connecting the signal generation unit with the lens, and the lens may focus the transmission signal on a specific region of the object. For example, the lens may include a collimator lens, and the transmission signal may be focused on a specific area of the object as the transmission signal is irradiated in parallel by the lens.

In operation S630, the method may include receiving a reception signal reflected (or scattered) from the object. For example, the LIDAR device may receive a reception signal reflected (or scattered) from the object. Some of the transmission signals irradiated to the object may be reflected from the object and returned to the LiDAR device. The LiDAR device may receive a reception signal reflected from the object through a reception unit.

For example, the ToF driving type LiDAR device may include a reception unit that detects a pulse-type optical signal reflected from an object and outputs the detected optical signal as an electrical signal (e.g., a voltage signal). The reception unit may include a light receiving element that generates an electric signal by light energy of the optical signal. An avalanche photo diode (APD) or a single photon avalanche diode (SPAD) may be employed as the receiving unit. The reception unit may detect the pulse-type optical signal by receiving the pulse-type optical signal reflected from the object using a light receiving element such as an APD and a SPAD.

As another example, the FMCW driving type LiDAR device may include a reception unit that receives a reception signal reflected from an object and a local oscillator signal and outputs a beat signal. The reception unit may include a balanced photodetector. The reception unit may receive a local oscillator signal in a first direction and a reception signal in a second direction through the balanced photo detector. Accordingly, the reception unit may detect, in the form of analog electrical signals, a local oscillator signal, a reception signal, and a beat signal due to an interference phenomenon between the local oscillator signal and the reception signal.

The LiDAR device may include a lens for focusing the reception signal on the photodetector. In this case, the lens may be the same lens as a lens for focusing a transmission signal on an object. For example, the lens may include a collimator lens or a scanning lens, and the reception signal may be focused on the photodetector by finely adjusting the travel path of the reception signal by the lens.

The LiDAR device may further include an analog-to-digital converter. The analog-to-digital converter may convert a pulse-type optical signal or a pulse-type beat signal into a digital signal. For example, the analog-to-digital converter may perform analog-to-digital conversions on pulse-type optical signals by sampling signals for each of a plurality of pulses of pulse-type optical signals. As another example, the analog-to-digital converter may perform analog-to-digital conversion on the beat signal by sampling and quantizing the beat signal.

In operation S640, the method may including obtaining correction coefficient. For example, the LiDAR device may obtain a correction coefficient for correcting the light intensity of the reception signal through the optical ray simulation. The optical ray simulation may calculate a ratio of the light intensity of the reception signal to the light intensity of the transmission signal, and obtain a correction coefficient for correcting the light intensity of the reception signal based on the ratio.

A portion of the transmitted signal irradiated by the LiDAR device may be reflected by the object to form a reception signal. In an example case in which the transmission signal is reflected from the object, the transmission signal may be uniformly reflected (or scattered) in all directions. Since the transmission signal is an optical signal, the transmission signal may be reflected based on the Lambertian reflectance. That is, the transmission signal may be reflected with the same intensity in all directions when the transmission signal touches the surface of the object. Accordingly, the strength of the reception signal received by the LIDAR device will be weakened compared to the transmission signal, and the strength of the reception signal will be weakened even more as the distance between the LIDAR device and the object increases.

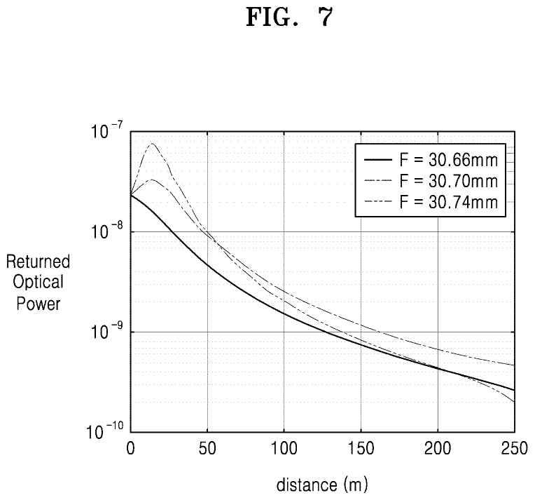

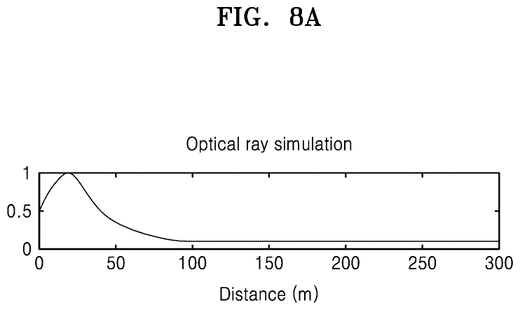

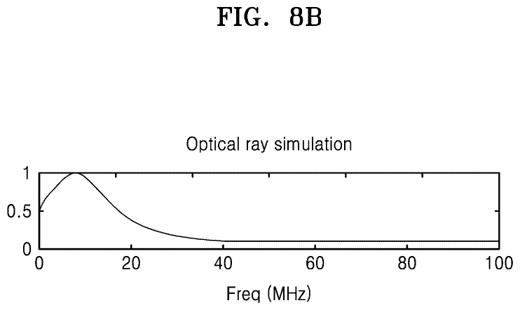

Hereinafter, in order to compensate for this phenomenon with reference to FIGS. 7 and 8, a process of obtaining a correction coefficient for correcting the light intensity of a reception signal through optical ray simulation will be described in more detail.

FIG. 7 is a graph illustrating a correction coefficient obtained through an optical ray simulation according to an embodiment. Referring to FIG. 7, in an example case in which the focal length of the lens of the LIDAR device is 30.66 mm, 30.70 mm, and 30.74 mm, the ratios of the light intensity of the reception signal to the light intensity of the transmission signal are illustrated as a solid line, a single-dot line, and a double-dot line, respectively.

The optical ray simulation may execute a simulation for calculating a ratio of the light intensity of the reception signal to the light intensity of the transmission signal according to the distance between the LiDAR device and the object. For example, the optical ray simulation may calculate the ratio according to the distance to the object based on the specification of the LIDAR device.

According to some embodiments of the disclosure, the specification of the LIDAR device may mean information on components included in the LIDAR device and information on factors determining the performance of the LIDAR device. For example, the specifications of the LIDAR device may include the focal length of the lens, the diameter of the lens, the area of the optical connector, and the wavelength of the optical signal generated by the signal generation unit.

Depending on the specifications of the LIDAR device, the measurement results of the LIDAR device may vary very sensitively. In an example case in which at least some of the specifications of the LIDAR device change, the magnitude of the light intensity of the reception signal received by the LIDAR device may vary significantly. The optical ray simulation may accurately calculate the magnitude of the light intensity required for correction by calculating the ratio of the light intensity of the reception signal to the light intensity of the transmission signal in consideration of the specifications of the LIDAR device.

FIGS. 8A and 8B show graphs illustrating a correction coefficient for correcting a light intensity of a reception signal. The graph in FIG. 8A shows a first correction coefficient for correcting the light intensity of the reception signal according to a distance, and the graph in FIG. 8B shows a second correction coefficient for correcting the light intensity of the reception signal according to a frequency.

The optical ray simulation may execute a simulation for calculating a first correction coefficient based on a ratio of the light intensity of the reception signal to the light intensity of the transmission signal. That is, the optical ray simulation may calculate a first correction coefficient, which is a correction coefficient for correcting the light intensity of the reception signal according to a distance. In this case, the optical ray simulation may be normalized so that the maximum value of the first correction coefficient becomes one (1).

Meanwhile, since the LiDAR device converts a reception signal or a beat signal into a frequency domain by using a fast Fourier transform, and detects a peak frequency in the changed frequency spectrum, a distance to the object and/or a speed of the object is detected, and thus, a correction coefficient for correcting the amount of the reception signal needs to be expressed in the frequency domain.

The optical ray simulation may further execute a simulation for converting the first correction coefficient into the second correction coefficient. That is, the optical ray simulation may calculate a second correction coefficient, which is a correction coefficient for correcting the light intensity of the reception signal according to the frequency, based on the first correction coefficient. In this case, the optical ray simulation may perform a normalization so that the maximum value of the second correction coefficient becomes one (1), but the process may be omitted in an example case in which the first correction coefficient is already normalized so that the maximum value is one (1).

For example, the optical ray simulation may convert the first correction coefficient into the second correction coefficient based on the frequency of the transmission signal. For example, the optical ray simulation may convert the first correction coefficient into the second correction coefficient based on the modulation bandwidth and modulation speed of the transmission signal. This is because the relationship shown in Equation 6 below is established between the distance between the LIDAR device and the object and the frequency f of the transmission signal.

$$\frac{f ( Hz )}{1 ( m )} = \frac{1}{c ( m / s ) \times slope ( Hz / s )} \qquad [ Equation 6 ]$$

In this case, c denotes the speed of light, and slope denotes the slope described with reference to FIG. 1, and may denote the speed at which the frequency of the transmission signal is modulated.

Meanwhile, the optical ray simulation may be a simulation stored in the memory of the LIDAR device and performed by the processor of the LIDAR device, but is not limited thereto. The optical ray simulation may be a simulation performed by an independent external device separate from the LiDAR device. In this case, the LIDAR device may be electrically or operatively connected to an external device or may receive the results of the optical ray simulation via wired or wireless communication.

Referring back to FIG. 6, in operation S650, the method may include detecting the distance between the LiDAR device and the object and/or the speed of the object by using the correction coefficient, the transmission signal, and the reception signal. For example, the LiDAR device may detect the distance between the LiDAR device and the object and/or the speed of the object by using the correction coefficient, transmission signal, and reception signal obtained in operation S640. For example, the LiDAR device may accurately detect distance information and/or speed information of the object by correcting a reception signal or beat signal using a correction coefficient.

The LiDAR device may correct the light intensity of the reception signal by dividing the reception signal or the beat signal by the correction coefficient. For example, a LiDAR device may convert a reception signal or beat signal into a frequency domain using fast Fourier transform and correct the light intensity of the reception signal by dividing the changed frequency spectrum by the second correction coefficient.

In this case, the LiDAR device may normalize the correction coefficient so that a ratio of the minimum value of the correction coefficient to the maximum value of the correction coefficient is less than a preset ratio. In an example case in which the LIDAR device divides the beat signal by the second correction coefficient, the second correction coefficient may be normalized so that the ratio of the minimum value of the second correction coefficient to the maximum value of the second correction coefficient is less than 10%. This is because, in an example case in which there is no restriction on the maximum and minimum values of the correction coefficient, unnecessary signals or noise are excessively included in the signal analysis process, which may distort the valid signal or make the analysis result inaccurate.

The LiDAR device may accurately detect distance information and/or speed information of the target object by analyzing the corrected reception signal or beat signal. For example, the LIDAR device may detect the distance to the object and/or speed of the object more accurately by detecting the peak frequency from the beat signal with which the light intensity of the reception signal has been corrected. As another example, the LiDAR device may detect a peak by using a reception signal in which the light intensity is corrected, thereby more accurately detecting a time of flight (ToF), and based on this, the distance to the object and/or speed of the object may also be detected more accurately.

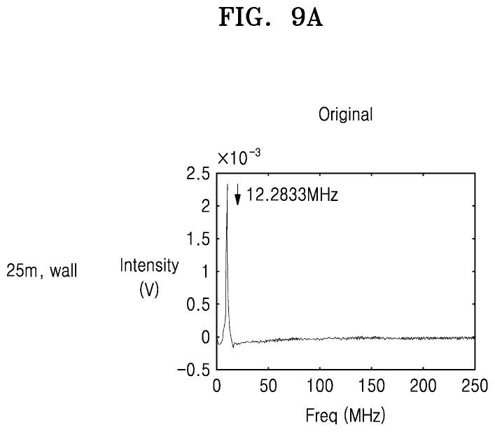

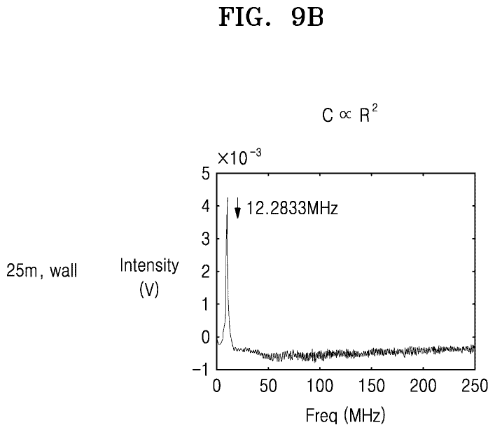

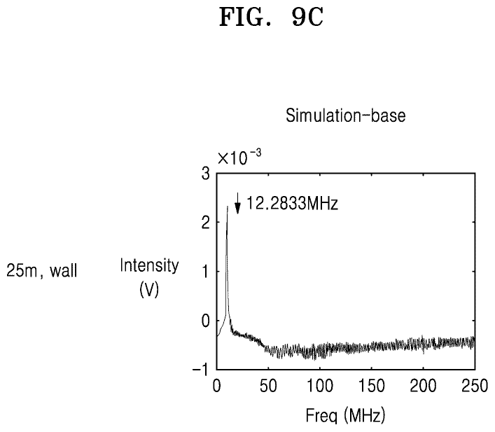

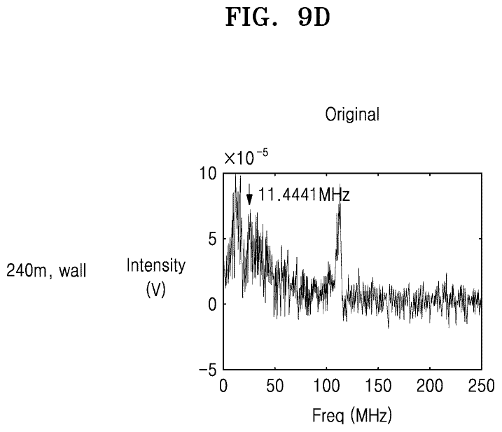

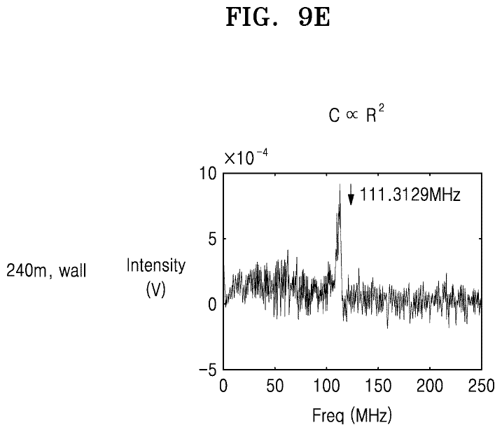

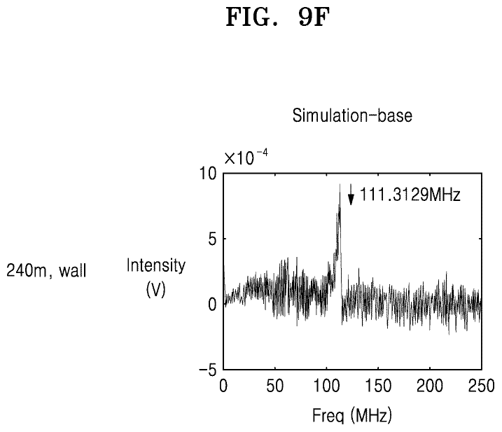

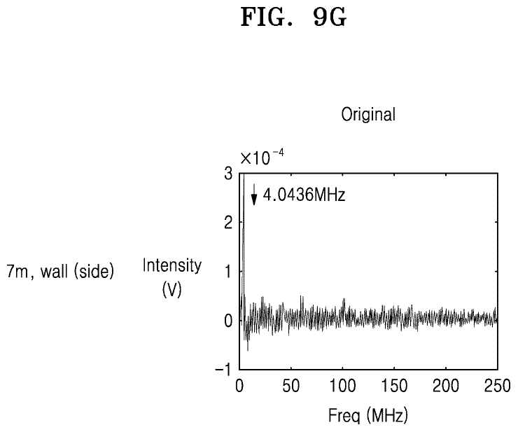

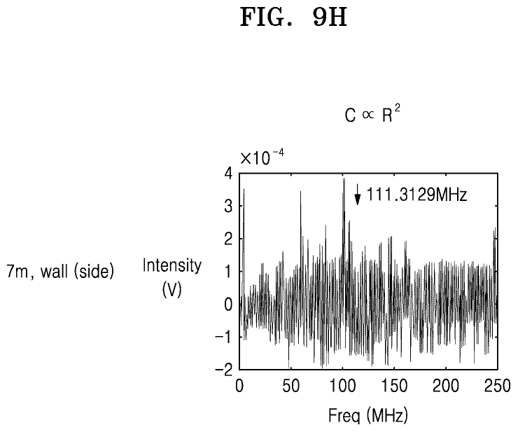

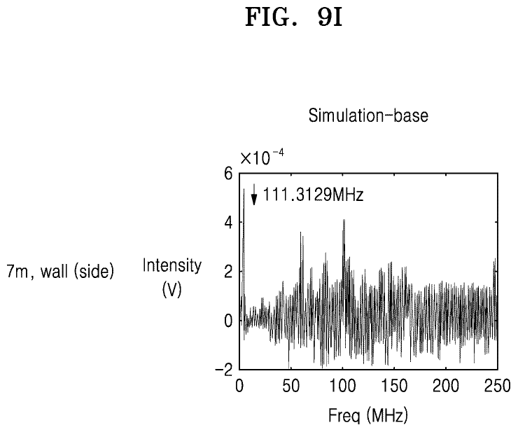

FIGS. 9A, 9B, 9C, 9D, 9E, 9F, 9G, 9H and 9I are graphs for comparing frequency spectra acquired by a LiDAR device for a near-field object, a far-field object, and an ultra-near-field object, according to various embodiments.

For example, FIGS. 9A, 9B, and 9C show frequency spectra obtained by the LiDAR device from a front wall 25 m away from the LiDAR device, FIGS. 9D, 9E, and 9F show frequency spectra obtained by the LiDAR device from a front wall 240 m away from the LiDAR device, and FIGS. 9G, 9H, and 9I show frequency spectra obtained by the LiDAR device from a side wall 7 m away from the LiDAR device.

Meanwhile, FIGS. 9A, 9D, and 9G show frequency spectra obtained by a related art LiDAR device, FIGS. 9B, 9E, and 9H show frequency spectra obtained by a LiDAR device (hereinafter referred to as a comparative LiDAR device) that corrects a beat signal by using an example in which a magnitude of the light amount of the reception signal decreases as the distance is squared, and FIGS. 9C, 9F, and 9I show frequency spectra obtained by a LiDAR device that corrects a beat signal using an optical ray simulation according to an embodiment of the disclosure.

Referring to FIGS. 9A, 9B, and 9C, it may be seen that the related art LiDAR device, the comparative LiDAR device, and the LiDAR device according to an embodiment of the disclosure all detect a peak frequency in about 12.3 MHz band for an object located in a short distance.

In addition, referring to FIGS. 9D, 9E, and 9F, the related art LiDAR device incorrectly detects that the object is located closer than the place where the object is actually located by detecting a peak frequency of about 11.4 MHz due to a lot of noise generated at a low frequency, but the comparative LiDAR device and the LiDAR device according to an embodiment of the disclosure detect a peak frequency of about 111.3 MHz, and thus it may be seen that the peak frequency is relatively accurately detected even for objects located at a long distance.

In addition, referring to FIGS. 9G, 9H, and 9I, it may be seen that the related art LiDAR device and the LiDAR device according to an embodiment of the disclosure may detect a peak frequency of about 4.0 MHz, and accurately detect a peak frequency even for an object located in a very close distance, but the comparative LiDAR device detects a peak frequency of about 100.4 MHz. In addition, comparing the graph in FIG. 9E with the graph in FIG. 9F, it may be seen that the signal acquired by the LiDAR device is much smaller even though the distance to the object in FIG. 9F is much closer than in FIG. 9E.

This is because the comparative LiDAR device uses a correction method using an example in which the light intensity of the reception signal decreases in proportion to the square of the distance. Since this method corrects the light intensity of the reception signal only based on the distance, the magnitude of the signal originating from the short distance becomes excessively small and the magnitude of the noise originating from the long distance becomes relatively large, making it difficult to accurately detect the peak frequency for the object located in the super short distance.

The LiDAR device according to an embodiment of the disclosure may calculate a ratio of the light intensity of the reception signal to the light intensity of the transmission signal through optical ray simulation, and obtain a correction coefficient for correcting the light intensity of the reception signal based on the ratio. Accordingly, the LiDAR device according to an embodiment of the disclosure may accurately detect distance information and/or speed for an object located at a long distance as well as at a very close distance by correcting a reception signal or beat signal using a correction coefficient.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An operating method of a light detection and ranging (LiDAR) device, the operating method comprising:
generating an optical signal;
irradiating a transmission signal towards an object, the transmission signal based on the optical signal;
receiving a reception signal reflected from the object;
obtaining, based on an optical ray simulation, a correction coefficient for correcting a light intensity of the reception signal; and
detecting a distance between the LiDAR device and the object or a speed of the object based on the transmission signal, the reception signal, and the correction coefficient.

2. The operating method of claim 1,
wherein the optical ray simulation comprises executing a simulation to obtain a first correction coefficient based on a ratio of the light intensity of the reception signal to a light intensity of the transmission signal, and
wherein the first correction coefficient is a correction coefficient for correcting the light intensity of the reception signal according to the distance.

3. The operating method of claim 2,
wherein the optical ray simulation further comprises converting the first correction coefficient into a second correction coefficient based on a frequency of the transmission signal, and
wherein the second correction coefficient is a correction coefficient for correcting the light intensity of the reception signal according to the frequency.

4. The operating method of claim 3, wherein the optical ray simulation further comprises normalizing the first correction coefficient or the second correction coefficient to have a maximum value of about 1.

5. The operating method of claim 1, wherein the optical ray simulation comprises executing a simulation to obtain the correction coefficient based on a specification of the LiDAR device.

6. The operating method of claim 1, wherein
wherein the generating of the optical signal comprises modulating a frequency of the optical signal over time,
wherein the receiving of the reception signal comprises generating a beat signal by mixing a local oscillator signal of the LiDAR device with the reception signal reflected from the object, and
wherein the detecting of the distance or the speed comprises detecting the distance or the speed using the beat signal and the correction coefficient.

7. The operating method of claim 6, wherein the detecting of the distance or the speed comprises correcting the light intensity of the reception signal by dividing the beat signal by the correction coefficient.

8. The operating method of claim 7, wherein the correcting of the light intensity of the reception signal comprises normalizing a ratio of a minimum value of the correction coefficient to a maximum value of the correction coefficient to be less than a first ratio.

9. The operating method of claim 6, wherein
wherein the optical ray simulation comprises:
executing a simulation to obtain a first correction coefficient based on a ratio of a light intensity of the reception signal to a light intensity of the transmission signal, and
converting the first correction coefficient into a second correction coefficient based on a modulation bandwidth of the transmission signal and a modulation speed of the transmission signal,
wherein the first correction coefficient is a correction coefficient for correcting the light intensity of the reception signal according to the distance, and
wherein the second correction coefficient is a correction coefficient for correcting the light intensity of the reception signal according to the frequency.

10. The operating method of claim 1, wherein
wherein the generating of the optical signal comprises generating the optical signal as a pulse-type signal, and
wherein the detecting of the distance or the speed comprises:
measuring a time period from a first time when the transmission signal is irradiated to a second time when the reception signal is received, and
detecting the distance or the speed based on the correction coefficient and the time period.

11. A light detection and ranging (LiDAR) device comprising:
a signal generator configured to generate an optical signal;
a transmitter configured to irradiate a transmission signal towards an object, the transmission signal based on the optical signal;
a receiver configured to receive a reception signal reflected from the object; and
a processor configured to:
obtain a correction coefficient for correcting a light intensity of the reception signal based on an optical ray simulation, and
detect a distance between the LIDAR device and the object or a speed of the object based on the transmission signal, the reception signal, and the correction coefficient.

12. The LiDAR device of claim 11,
wherein the correction coefficient comprises a first correction coefficient calculated based on a ratio of the light intensity of the reception signal to the light intensity of the transmission signal through the optical ray simulation, and
wherein the first correction coefficient is a correction coefficient for correcting the light intensity of the reception signal according to the distance.

13. The LiDAR device of claim 12,
wherein the correction coefficient comprises a second correction coefficient converted from the first correction coefficient based on a frequency of the transmission signal through the optical ray simulation, and
wherein the second correction coefficient is a correction coefficient for correcting the light intensity of the reception signal according to the frequency.

14. The LiDAR device of claim 13, wherein the first correction coefficient or the second correction coefficient is normalized to have a maximum value of 1 through the optical ray simulation.

15. The LiDAR device of claim 11, wherein the correction coefficient is obtained based on the specification of the LiDAR device through the optical ray simulation.

16. The LiDAR device of claim 11,
wherein a frequency of the optical signal is modulated over time,
wherein the receiver is further configured to generate a beat signal by mixing a local oscillator signal of the LiDAR device with a reception signal reflected from the object, and
wherein the processor is further configured to detect the distance or the speed using the beat signal and the correction coefficient.

17. The LiDAR device of claim 16, wherein the processor is further configured to correct the light intensity of the reception signal by dividing the beat signal by the correction coefficient.

18. The LiDAR device of claim 17, wherein the processor is further configured to:
obtain a normalized correction coefficient by normalizing a ratio of the minimum value of the correction coefficient to the maximum value of the correction coefficient to be less than a first ratio, and
correct the light intensity of the reception signal using the normalized correction coefficient.

19. The LiDAR device of claim 16,
wherein the correction coefficient comprises a first correction coefficient calculated based on a ratio of the light intensity of the reception signal to the light intensity of the transmission signal through the optical ray simulation and a second correction coefficient converted from the first correction coefficient based on a modulation bandwidth of the transmission signal and a modulation speed of the transmission signal through the optical ray simulation,
wherein the first correction coefficient is a correction coefficient for correcting the light intensity of the reception signal according to the distance, and
wherein the second correction coefficient is a correction coefficient for correcting the light intensity of the reception signal according to the frequency.

20. The LiDAR device of claim 11,
wherein the optical signal is generated as a pulse-type signal, and
wherein the processor is further configured to measure a time period from a time when the transmission signal is irradiated to a time when the reception signal is received and detects the distance or the speed based on the correction coefficient and the time period.
